(19) United States
(12) Patent Application Publication
(10) Pub. No.: US 2024/0028505 A1
(43) Pub. Date: Jan. 25, 2024

(54) MEMORY ALLOCATION BASED ON TIME

(71) Applicant: Intel Corporation, Santa Clara, CA (US)

(72) Inventors: Sharanyan SRIKANTHAN, Portland, OR (US); Thomas WILLHALM, Sandhausen (DE); Francesc GUIM BERNAT, Barcelona (ES); Karthik KUMAR, Chandler, AZ (US); Marcos E. CARRANZA, Portland, OR (US)

(21) Appl. No.: 18/375,477

(22) Filed: Sep. 30, 2023

(51) Int. Cl. G06F 12/02

(52) U.S. Cl. CPC G06F 12/023

(57) ABSTRACT

Examples described herein relate to allocation of an amount of memory for a time duration based on receipt of a request to allocate an amount of memory for a time duration. The request can include a configuration that requests an allocation of the amount of memory and the configuration specifies a time tier and/or the time duration. The request can specify one or more of: a request identifier, the amount of memory to allocate, or a requested time duration to reserve the amount of memory.

### BACKGROUND

Memory pools are utilized to provide access to scalable amounts of memory in dynamic random access memory (DRAM) devices. However, scaling an amount of memory in a memory pools has encountered challenges, such as capacity scaling, increasing costs for adding memory, and bandwidth scaling challenges. Compute Express Link (CXL) enables a variety of memory types (e.g., CXL Double Data Rate (DDR5) memory on riser cards, CXL DDR4 memory on riser cards, phase change memory (PCM) on CXL, Flash on CXL, etc.) to be accessible as memory and can potentially address some of the challenges with memory pools. A cloud service provider (CSP) can offer a pool of hosted CXL-connected memory as a memory pool. In turn, CSPs can offer tenants and end users a variety of options to utilize memory with different price points for different latency and bandwidth characteristics and different capacities.

There are scenarios where memory utilization increases to multiples of average usage. Worst case peaks can be periodic or deterministic, such as end of quarter or shopping seasons (e.g., start of school year in August and September, Friday sales, holiday sales, etc.). Over provisioning memory to account for peak usages can result in wasted capacity during average usages.

### BRIEF DESCRIPTION OF THE DRAWINGS

FIG. 1 shows an example system.

FIG. 2 depicts an example process.

FIG. 3 depicts an example system.

### DETAILED DESCRIPTION

Various examples provide an interface with parameters to request a starting time and time duration that an amount of memory is to be allocated. The interface can include an application program interface (API), configuration file, executable binary, or other messages or commands. The time duration can be specified in seconds, minutes, hours, or fractions or multiples thereof. For example, a requester can include a process and an operating system (OS) can provide the interface. In some examples, the requester can include an OS and an orchestrator can provide the interface. The OS and/or the orchestrator can manage memory allocations such as timed usage, extension of time, and de-allocation of memory. The OS and/or orchestrator can track address ranges and expiration deadlines for memory borrowed from one or more memory pools. The OS and/or the orchestrator can perform malloc( ) or mmap( ) based on the parameters specified in the interface. A requester can borrow memory of different technologies (e.g., memory types or memory interfaces), for a specified duration of time, from one or multiple pools of memory with different costs per amount of memory (e.g., dollar ($) per gigabyte (GB)). Moreover, the process, OS, and orchestrator can negotiate and manage memory allocations with temporal semantics, from memory pools.

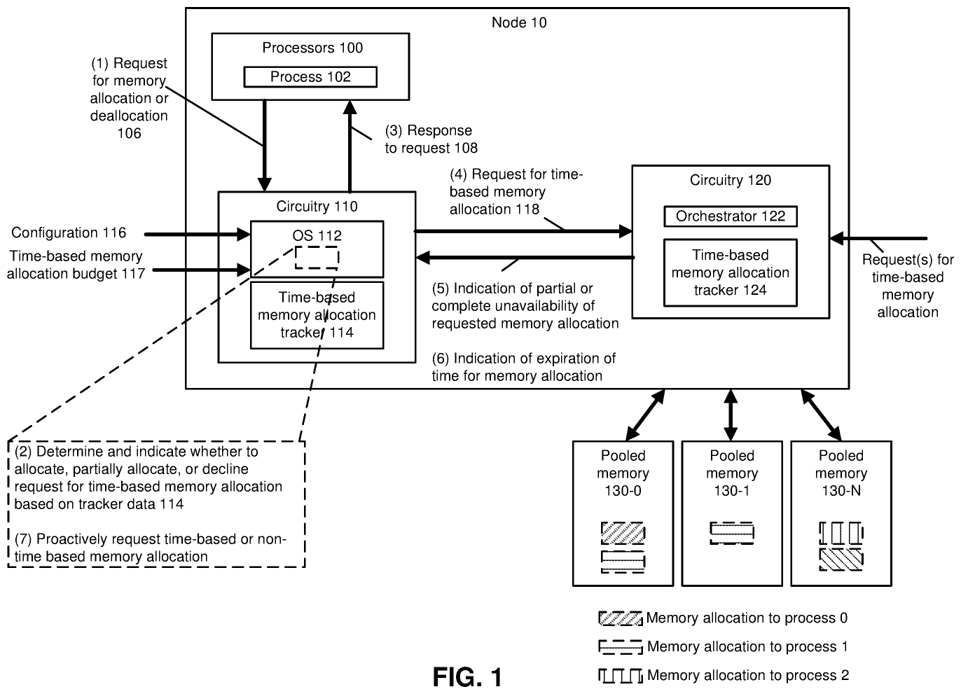

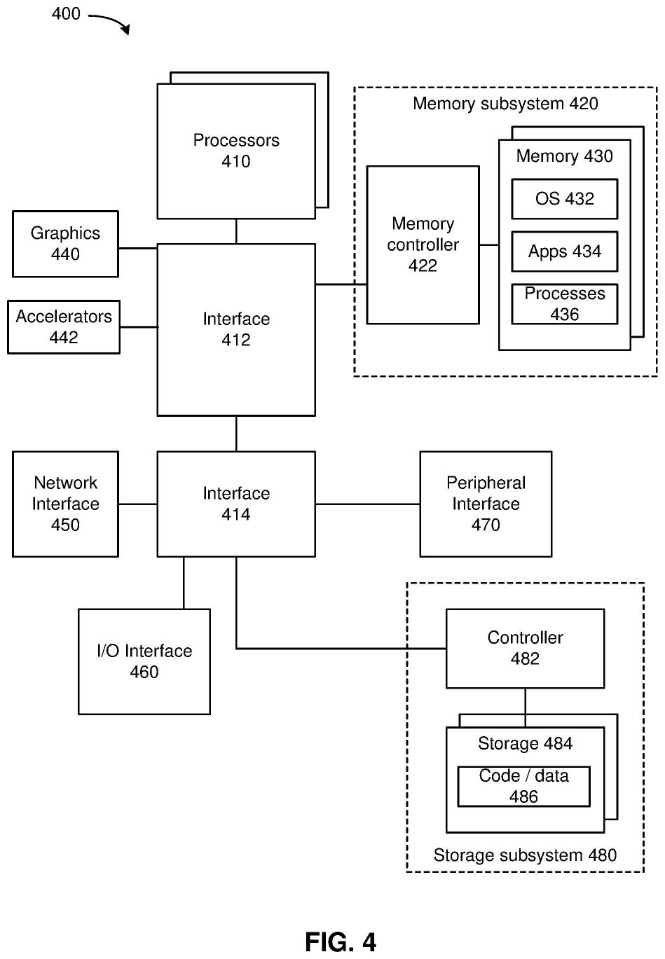

FIG. 1 depicts an example system. Node 10 can include processors 100, circuitry 110, and/or circuitry 120 as well as other circuitry and software described at least with respect to FIG. 3. Processors 100, circuitry 110, and/or circuitry 120 can include one or more of the following: central processing units (CPUs), graphics processing units (GPUs), XPUs, and so forth); one or more accelerators; one or more application specific integrated circuits (ASICs); one or more field programmable gate arrays (FPGAs); one or more graphics processing units (GPUs); one or more memory devices; one or more storage devices; one or more network interface devices; or others.

In some examples, processors 100, circuitry 110, and/or circuitry 120 can execute process 102. Process 102 can be implemented as one or more of: application, microservice, virtual machine (VM), microVMs, container, thread, or other virtualized execution environment.

For example, process 102 can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in process 102. VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. Some processes can perform video processing or media transcoding (e.g., changing the encoding of audio, image, or video files).

In some examples, processors 100, circuitry 110, and/or circuitry 120 can execute operating system (OS) 112. OS 112 can receive configuration 116 indicating whether to perform memory allocation based on time or non-time based manner from a system administrator or orchestrator 122. In addition, OS 112 can receive budget configuration 117 that indicates an allocation of time-based memory to process or tenant identifiers. For example, for a tenant or process, budget configuration 117 can indicate a limit on an amount of memory to allocate, a class of memory that is available to allocate, a duration of time that the amount and class of memory are permitted to be allocated, or others. Budget configuration 117 can specify a budget in terms of cost per amount of time allocate to a particular tenant or process by process identifier. For example, a system administrator can specify budget 117 based on a service level agreement (SLA) or service level objective (SLO) for a tenant or process 102.

Based on authentication of configuration 116 and budget 117, such as by validation of a checksum or other integrity check, OS 112 can apply configuration 116 and budget 117.

Process 102 can issue request 106 to OS 112. As described herein, request 106 can include parameters of a memory allocation that includes a starting time and time duration as well as amount of memory to allocate (e.g., in bytes or bit sizes). In some examples, request 106 can include one or more of the following fields or parameters: request identifier, starting time when desired, time duration, amount of memory requested, time tier of memory (e.g., speed of memory read or write, memory interface latency or bandwidth or type, connection latency or bandwidth), processing identifier (e.g., Process Address Space identifier (PASID)).

A time tier of memory can be based on memory interface type, such as at least: DDR3 (Double Data Rate version 3, original release by JEDEC (Joint Electronic Device Engineering Council) on Jun. 16, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), DDR version 5, CXL, Peripheral Component Interconnect Express (PCIe), or others or combinations of memory technologies, and technologies based on derivatives or extensions of such specifications.

A time tier of memory can be based on type of memory technology (e.g., speed of memory read or write) such as at least: cache, static random-access memory (SRAM), DRAM, flash memory, phase change stored accessible as memory.

Based on time-based memory allocation tracker 114, configuration 116, and budget 117, OS 112 can determine whether to accept, reject, or partially accept request 106. Based on configuration 116, budget 117, and tracker 114, OS 112 may fulfill request 106 either from free page lists (e.g., DRAM or CXL-connected memory) or request time leased memory via orchestrator 122 from one or more of memory pools 130-0 to 130-N, where N is an integer. Time-based memory allocation tracker 114 can indicate virtual or physical memory address ranges (e.g., starting and ending or physical virtual memory addresses) that are allocated to particular processes or circuitry. In some cases, time-based memory allocation tracker 114 can indicate a duration or time span that virtual memory address ranges are allocated to particular processes or circuitry. OS 112 can provide a response 108 (e.g., accept, reject, or partially accept request 106) to process 102. In some examples, where a requested time tier of memory is not available, a slower time tier of memory can be allocated in response 108 for a longer time duration than requested.

An example format of tracker 114 is as follows.

| | | | | |
|---|---|---|---|---|
| Request ID | Memory region | Start time | Duration | Process |
| | (starting and | | | identifier |
| | ending address) | | | |

Response 108 can include one or more of the following parameters or fields: approved, partially approved, declined, and (for an approved request), a pointer to start address of memory allocation location. Where response 108 is a partial accept, response 108 can include an indication of a counteroffer of available time tier, available amount of memory, available start time, and/or available duration.

Time-based memory allocation tracker 114 can include an address range temporal hash map. OS 112 and/or orchestrator 122 can use an input of time parameter with a memory allocation, to implement a hash map in tracker 114. Tracker 114 can store address ranges and corresponding time deadlines using the current time-of-day and requested duration time in seconds based on allocated memory address ranges. OS 112 and/or orchestrator 122 can use the time parameter from an approved memory deallocation request to correspondingly update the time-based hash map.

Circuitry (e.g., processors 100, circuitry 110, and/or circuitry 120) can enter lower power state and execute a TPAUSE instruction and OS 112 and/or orchestrator 122 (or other software, firmware, or circuitry) can perform memory deallocation when a time deadline approaches as specified in tracker 114. In some examples, OS 112 can transmit request 118 to orchestrator 122 to allocate memory for a time duration in accordance with request 106.

In some examples, processors 100, circuitry 110, and/or circuitry 120 can execute orchestrator 122. In some examples, OS 112 can provide data to orchestrator 122 to perform deallocation of a memory region based on expiration of a timer for the memory region. For example, orchestrator 122 can determine memory address ranges allocated in one or more pooled memory 130-0 to 130-N based on data in request 118. Orchestrator 122 can update time-based memory allocation tracker 124 based on data in request 118. While not shown, orchestrator 122 can receive requests for time-based memory allocation from one or more of: another process, another OS, and another orchestrator. The another process, another OS, and another orchestrator can be within or executed by node 10 or another node.

OS 112 can track time-based leases on pooled memory, and notify orchestrator 122 to extend the lease based on a potential budget, or other criteria, from budget 117. If address range temporal tracker 114 indicates that the allocated time is concluded for a memory range, OS 112 can revert to a set of options, registered by the application or system administrator such as proactively requesting an extension of time for the memory region or indicating to process 102 that an entirety or less than an entirety of the memory address region is no longer allocated. Process 102 can receive an indication from OS 112 or orchestrator 122 that an amount of memory was proactively requested for a particular start time and duration, to potentially avoid a duplicate request from process 102.

OS 112 can predict start time, duration of time, and amount of memory usages of process 102 based on machine learning (ML) and/or artificial intelligence (AI) inferences. For example, based on time-based or system event-based usage trends of process 102 or other processes, OS 112 can proactively request a predicted memory allocation amount from orchestrator 122 at a specific start time and for a specified duration of time by another issuance of request 118. For example, a time-based trend can be end of season, end of quarter, holiday season, or others. For example, a system event can include a number of page fault events triggered by process 102.

In some examples, process 102 does not utilize formerly allocated memory and can issue a deallocation request 106 to free a corresponding address range for allocation to another process. For example, deallocation request 106 can indicate one or more of: request identifier, starting address, amount of memory to retain or free, or delay until release. In some examples, deallocation request 106 follow a same format as an allocation request 106 but indicate a time duration of zero (0) or a shorter time duration than previously requested to reduce the lease on memory. When a time duration of zero is specified, OS 112 and/or orchestrator 122 can free the memory region immediately. However, when a delay until release time is specified in seconds, OS 112 and/or orchestrator 122 can free the memory region after delay until release time. Conversely, if the delay until release is a longer time duration than what was allocated previously or is remaining, OS 112 and/or orchestrator 122 can extend the memory lease for the previously memory region until the delay until release time is met. In response to a request to shorten or length a memory allocation, OS 112 can issue response 108 that indicates one or more of: request identifier and response (e.g., approved, partially approved, or denied). A partial approval can follow a same format as a partial approval for a request for memory allocation 106, described earlier.

Orchestrator 122 can provide an interface to one or multiple memory pools 130-0 to 130-N, where N is an integer, and can track memory region allocations and time durations in tracker 124. When the time requested expires, orchestrator 122 can communicate with the operating system, which may decide to extend the lease, free up the memory, or provide an out of memory notification to process 102. A determination to extend the lease, free up the memory, or provide an out of memory notification can be made based on configuration 116 and budget 117.

Node 10 can access one or more memory pools 130-0 to 130-N via one or more of: a device interface, memory interface, a network (e.g., Ethernet), or other interconnect technologies described with respect to the system of FIG. 3. A memory pool can include one or more memory pools with dual inline memory modules (DIMMs) or other memory. Memory can include one or more of: one or more registers, one or more cache devices (e.g., level 1 cache (L1), level 2 cache (L2), level 3 cache (L3), last level cache (LLC)), volatile memory device, non-volatile memory device, or persistent memory device. For example, memory can include static random access memory (SRAM) memory technology or memory technology consistent with high bandwidth memory (HBM), or double data rate (DDR), among others.

One or more memory pools 130-0 to 130-N can be accessed as a local device or a remote memory pool through a device interface, switch, or network. A memory pool can be shared by multiple servers or processors. One or more memory pools 130-0 to 130-N can include at least two levels of memory (alternatively referred to herein as “2LM” or tiered memory) can be used that includes cached subsets of system disk level storage (in addition to, for example, run-time data). This main memory includes a first level (alternatively referred to herein as “near memory”) including lower latency and/or higher bandwidth memory made of, for example, dynamic random access memory (DRAM) or other volatile memory; and a second level (alternatively referred to herein as “far memory”) which includes higher latency and/or lower bandwidth (with respect to the near memory) volatile memory (e.g., DRAM) or nonvolatile memory storage (e.g., flash memory or byte addressable non-volatile memory (e.g., Intel Optane®)). The far memory can be presented as “main memory” to the host operating system (OS), while the near memory can include a cache for the far memory that is transparent to the OS. The management of the two-level memory may be performed by a combination of circuitry and modules executed via the host central processing unit (CPU). Near memory may be coupled to the host system CPU via high bandwidth, low latency connection for low latency of data availability. Far memory may be coupled to the CPU via low bandwidth, high latency connection (as compared to that of the near memory), via a network or fabric, or a similar high bandwidth, low latency connection as that of near memory. Far memory devices can exhibit higher latency or lower memory bandwidth than that of near memory. For example, Tier 2 memory can include far memory devices and Tier 1 can include near memory.

One or more memory pools 130-0 to 130-N can be accessed as a virtual device by hardware-assisted input/output (I/O) virtualization that defines a manner for partitioning endpoint devices for direct sharing across multiple processes. Examples of hardware-assisted I/O virtualization are based on virtualization standards such as Single Root I/O Virtualization (SR-IOV) or Scalable Input/Output (I/O) Virtualization (S-IOV).

An example operation of the system is as follows. At (1), process 102 can issue a request to OS 112 for allocation of an amount of memory of a time tier for a time duration. At (2), OS 112 can determine to accept, reject, or partially accept the request. At (3), the OS can provide the response in response 108. At (4), based on acceptable or partial acceptance of the request 106 (e.g., less than the request amount of memory, less than the requested time tier, and/or less than the requested time duration), OS 112 can issue a request to allocate the approved amount of memory for the approved time duration to orchestrator 122. In some examples, the partial acceptance can be meet an SLA of process 102. At (5), orchestrator 122 can allocate the approved amount of memory for the approved time duration in one or more of memory pools 130-0 to 130-N. At (6), orchestrator 122 can indicate expiration of the time duration to OS 112. At (7), OS 112 can proactively request allocation of an amount of memory for process 102 based on past usages of memory.

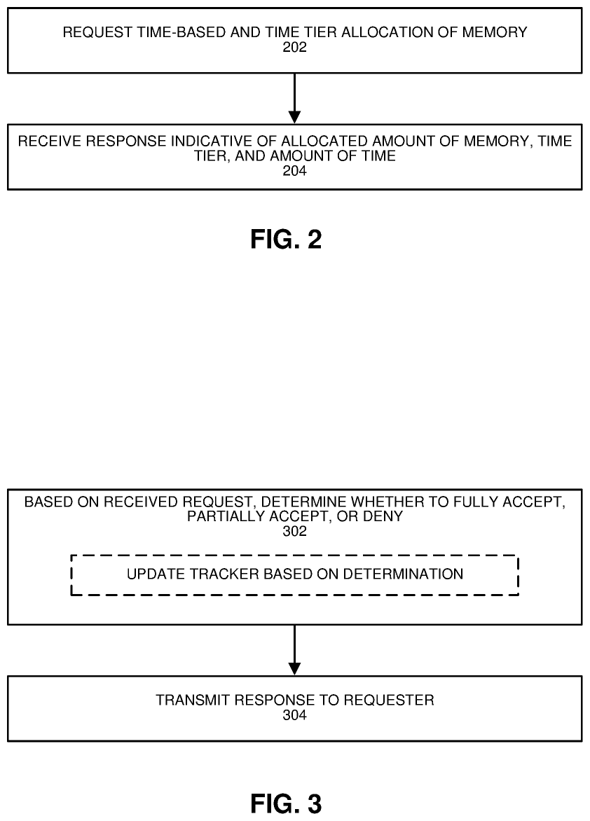

FIG. 2 depicts an example process. The process can be performed by a process such as a virtual machine, container, application, or others. At 202, the process can provide a request for an allocation of an amount of memory for a duration of time as well as a starting time for the allocation of the amount of memory and a time tier of the memory. In some examples, the process can issue the request to an OS and/or orchestrator. At 204, the process can receive a response to the request indicative of an allocated amount of memory, allocate duration of time, allocated starting time for the allocation of the amount of memory, and allocated a time tier of the memory. Subsequently, the process can issue a request to increase or decrease one or more of: the duration of time, the amount of memory, and/or the time tier of memory.

FIG. 3 depicts an example process. The process can be performed by an OS and/or orchestrator, or others. At 302, a determination can be made as to whether to accept, partially accept, or decline a received request for an allocation of an amount of a time tier of memory for a duration of time. For example, the determination can be made based on a tracker indicating allocated memory, time tiers of allocated memory, and time that the memory is allocated as well as an SLA associated with the requester. For example, the request can be accepted if the request can be fulfilled. For example, the request can be partially accepted if a portion of the request can be accepted. For example, the request can be declined if none of the request can be met given the tracker and applicable SLA.

At 304, a response can be transmitted to the request indicative of the determination.

FIG. 4 depicts a system. In some examples, circuitry of system 400 can allocate an amount of a time tier of memory for a time duration, as described herein. System 400 includes processor 410, which provides processing, operation management, and execution of instructions for system 400. Processor 410 can include any type of microprocessor, central processing unit (CPU), graphics processing unit (GPU), XPU, processing core, or other processing hardware to provide processing for system 400, or a combination of processors. An XPU can include one or more of: a CPU, a graphics processing unit (GPU), general purpose GPU (GPGPU), and/or other processing units (e.g., accelerators or programmable or fixed function FPGAs). Processor 410 controls the overall operation of system 400, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 400 includes interface 412 coupled to processor 410, which can represent a higher speed interface or a high throughput interface for system components that needs higher bandwidth connections, such as memory subsystem 420 or graphics interface components 440, or accelerators 442. Interface 412 represents an interface circuit, which can be a standalone component or integrated onto a processor die. Where present, graphics interface 440 interfaces to graphics components for providing a visual display to a user of system 400. In one example, graphics interface 440 generates a display based on data stored in memory 430 or based on operations executed by processor 410 or both. In one example, graphics interface 440 generates a display based on data stored in memory 430 or based on operations executed by processor 410 or both.

Accelerators 442 can be a programmable or fixed function offload engine that can be accessed or used by a processor 410. For example, an accelerator among accelerators 442 can provide data compression (DC) capability, cryptography services such as public key encryption (PKE), cipher, hash/authentication capabilities, decryption, or other capabilities or services. In some cases, accelerators 442 can be integrated into a CPU socket (e.g., a connector to a motherboard or circuit board that includes a CPU and provides an electrical interface with the CPU). For example, accelerators 442 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 442 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 420 represents the main memory of system 400 and provides storage for code to be executed by processor 410, or data values to be used in executing a routine. Memory subsystem 420 can include one or more memory devices 430 such as read-only memory (ROM), flash memory, one or more varieties of random access memory (RAM) such as DRAM, or other memory devices, or a combination of such devices. Memory 430 stores and hosts, among other things, operating system (OS) 432 to provide a software platform for execution of instructions in system 400. Additionally, applications 434 can execute on the software platform of OS 432 from memory 430. Applications 434 represent programs that have their own operational logic to perform execution of one or more functions. Processes 436 represent agents or routines that provide auxiliary functions to OS 432 or one or more applications 434 or a combination. OS 432, applications 434, and processes 436 provide software logic to provide functions for system 400. In one example, memory subsystem 420 includes memory controller 422, which is a memory controller to generate and issue commands to memory 430. It will be understood that memory controller 422 could be a physical part of processor 410 or a physical part of interface 412. For example, memory controller 422 can be an integrated memory controller, integrated onto a circuit with processor 410.

Applications 434 and/or processes 436 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 432 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

In some examples, OS 432, a system administrator, and/or orchestrator can allocate an amount of a time tier of memory for a time duration, as described herein.

While not specifically illustrated, it will be understood that system 400 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 400 includes interface 414, which can be coupled to interface 412. In one example, interface 414 represents an interface circuit, which can include standalone components and integrated circuitry. In one example, multiple user interface components or peripheral components, or both, couple to interface 414. Network interface 450 provides system 400 the ability to communicate with remote devices (e.g., servers or other computing devices) over one or more networks. Network interface 450 can include an Ethernet adapter, wireless interconnection components, cellular network interconnection components, USB (universal serial bus), or other wired or wireless standards-based or proprietary interfaces. Network interface 450 can transmit data to a device that is in the same data center or rack or a remote device, which can include sending data stored in memory. Network interface 450 can receive data from a remote device, which can include storing received data into memory. In some examples, packet processing device or network interface device 450 can refer to one or more of: a network interface controller (NIC), a remote direct memory access (RDMA)-enabled NIC, SmartNIC, router, switch, forwarding element, infrastructure processing unit (IPU), or data processing unit (DPU).

In some examples, management controller 444 can perform one or more of: retrieval of server identification and asset information (e.g., health state, temperature sensors and fans, power supply output levels, platform power consumption and thresholds, input/output (I/O) infrastructure data (e.g., host network interface controller media access control (MAC) address(es)) for devices to be managed (e.g., lights-out management (LOM) devices), hard drive status or fault reporting, network-based discovery of service endpoint, discovery of system topology (e.g., rack, chassis, server, node), reboot or power cycle server with connected devices, change boot order of devices, set power thresholds, alert or event notifications, event log access, access and configure management controller network settings, manage management controller user accounts, performing power distribution across the different parts of the system, allocating power management of the host system and network interface device 450, configuring frequency or power of operation of cores and network interface device 450, memory management of host system and network interface device 450, control of software updates of host system and network interface device 450, or control of firmware updates of host system and network interface device 450.

In one example, system 400 includes one or more input/output (I/O) interface(s) 460. I/O interface 460 can include one or more interface components through which a user interacts with system 400. Peripheral interface 470 can include any hardware interface not specifically mentioned above. Peripherals refer generally to devices that connect dependently to system 400.

In one example, system 400 includes storage subsystem 480 to store data in a nonvolatile manner. In one example, in certain system implementations, at least certain components of storage 480 can overlap with components of memory subsystem 420. Storage subsystem 480 includes storage device(s) 484, which can be or include any conventional medium for storing large amounts of data in a nonvolatile manner, such as one or more magnetic, solid state, or optical based disks, or a combination. Storage 484 holds code or instructions and data 486 in a persistent state (e.g., the value is retained despite interruption of power to system 400). Storage 484 can be generically considered to be a “memory,” although memory 430 is typically the executing or operating memory to provide instructions to processor 410. Whereas storage 484 is nonvolatile, memory 430 can include volatile memory (e.g., the value or state of the data is indeterminate if power is interrupted to system 400). In one example, storage subsystem 480 includes controller 482 to interface with storage 484. In one example controller 482 is a physical part of interface 414 or processor 410 or can include circuits or logic in both processor 410 and interface 414.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 400 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 400 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal (e.g., active-low or active-high). The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.
Example 1 can include one or more examples and can include at least one non-transitory computer-readable medium comprising instructions, that if executed, cause circuitry to: receive a request to allocate an amount of memory for a time duration based on receipt of a configuration that requests an allocation of the amount of memory and the configuration specifies a time tier and/or the time duration and allocate the amount of memory for the time duration.
Example 2 can include one or more examples, wherein the request is to specify one or more of: a request identifier, the amount of memory to allocate, or a requested time duration to reserve the amount of memory.
Example 3 can include one or more examples, wherein the time tier is associated with a speed of read and/or write operations and connection latency to access the memory.
Example 4 can include one or more examples, comprising instructions, that if executed, cause the circuitry to: based on receipt of the request, provide a response, wherein the response comprises: allocated, partially allocated, or rejected.
Example 5 can include one or more examples, comprising instructions, that if executed, cause the circuitry to: based on receipt of a second request, deallocate the allocated amount of memory prior to expiration of the time duration.
Example 6 can include one or more examples, comprising instructions, that if executed, cause the circuitry to: allocate a second amount of memory for a second time duration based on receipt of a second configuration that requests an allocation of the second amount of memory and the second configuration specifies a second time tier, wherein the second time duration is based on the time tier and wherein the second configuration was generated automatically based on a predicted usage of memory by a process.
Example 7 can include one or more examples, wherein the memory is part of a memory pool and wherein the memory pool comprising one or more device interface-connected memory devices comprise one or more memory devices connected via one or more of: a device interface, an Ethernet-based network, or memory interface.
Example 8 can include one or more examples, wherein the instructions comprise one or more of: an operating system (OS), an orchestrator, or a process.
Example 9 can include one or more examples, and includes a method that includes: a process issuing a request to allocate an amount of memory for a time duration, wherein the request comprises a configuration that requests an allocation of the amount of memory, the configuration specifies a time tier, and the time duration is based on the time tier and receiving a response to the request.
Example 10 can include one or more examples, wherein the request is to specify one or more of: a request identifier, the amount of memory to allocate, or a requested time duration to reserve the amount of memory.
Example 11 can include one or more examples, wherein the time tier is associated with a speed of read and/or write operations and connection latency to access the memory.
Example 12 can include one or more examples, wherein the response comprises: allocated, partially allocated, or rejected.
Example 13 can include one or more examples, and includes the process issuing a second request to request deallocation of a portion of the allocated amount of memory prior to expiration of the time duration.
Example 14 can include one or more examples, and includes the process receiving an indication of a second allocation of memory for a second start time and second duration of time, independent of the process requesting the second allocation of memory, wherein the second allocation of memory was based on a predicted usage of memory by the process.
Example 15 can include one or more examples, an apparatus that includes: an interface and circuitry to: receive a request to allocate an amount of memory for a time duration based on receipt of a configuration that requests an allocation of the amount of memory and the configuration specifies a time tier, wherein the time duration is based on the time tier and allocate the amount of memory for the time duration.
Example 16 can include one or more examples, wherein the request is to specify one or more of: a request identifier, the amount of memory to allocate, or a requested time duration to reserve the amount of memory.
Example 17 can include one or more examples, wherein the time tier is associated with a speed of read and/or write operations and connection latency to access the memory.
Example 18 can include one or more examples, wherein the circuitry is to: based on receipt of a second configuration that requests an allocation of a second amount of memory and the second configuration specifies a second time tier, allocate a second amount of memory for a second time duration, wherein the second time duration is based on the time tier and wherein the second configuration was generated automatically based on a predicted usage of memory by a process.
Example 19 can include one or more examples, wherein the memory is part of a memory pool and wherein the memory pool comprising one or more device interface-connected memory devices comprise one or more memory devices connected via one or more of: a device interface, an Ethernet-based network, or memory interface.
Example 20 can include one or more examples, wherein the request is associated with one or more of: a process, an operating system (OS), or an orchestrator.

1. At least one non-transitory computer-readable medium comprising instructions, that if executed, cause circuitry to:
receive a request to allocate an amount of memory for a time duration based on receipt of a configuration that requests an allocation of the amount of memory and the configuration specifies a time tier and/or the time duration and
allocate the amount of memory for the time duration.

2. The computer-readable medium of claim 1, wherein the request is to specify one or more of: a request identifier, the amount of memory to allocate, or a requested time duration to reserve the amount of memory.

3. The computer-readable medium of claim 1, wherein the time tier is associated with a speed of read and/or write operations and connection latency to access the memory.

4. The computer-readable medium of claim 1, comprising instructions, that if executed, cause the circuitry to:
based on receipt of the request, provide a response, wherein the response comprises: allocated, partially allocated, or rejected.

5. The computer-readable medium of claim 1, comprising instructions, that if executed, cause the circuitry to:
based on receipt of a second request, deallocate the allocated amount of memory prior to expiration of the time duration.

6. The computer-readable medium of claim 1, comprising instructions, that if executed, cause the circuitry to:
allocate a second amount of memory for a second time duration based on receipt of a second configuration that requests an allocation of the second amount of memory and the second configuration specifies a second time tier, wherein the second time duration is based on the time tier and wherein the second configuration was generated automatically based on a predicted usage of memory by a process.

7. The computer-readable medium of claim 1, wherein the memory is part of a memory pool and wherein the memory pool comprising one or more device interface-connected memory devices comprise one or more memory devices connected via one or more of: a device interface, an Ethernet-based network, or memory interface.

8. The computer-readable medium of claim 1, wherein the instructions comprise one or more of: an operating system (OS), an orchestrator, or a process.

9. A method comprising:
a process issuing a request to allocate an amount of memory for a time duration, wherein the request comprises a configuration that requests an allocation of the amount of memory, the configuration specifies a time tier, and the time duration is based on the time tier and
receiving a response to the request.

10. The method of claim 9, wherein the request is to specify one or more of: a request identifier, the amount of memory to allocate, or a requested time duration to reserve the amount of memory.

11. The method of claim 9, wherein the time tier is associated with a speed of read and/or write operations and connection latency to access the memory.

12. The method of claim 9, wherein the response comprises: allocated, partially allocated, or rejected.

13. The method of claim 9, comprising:
the process issuing a second request to request deallocation of a portion of the allocated amount of memory prior to expiration of the time duration.

14. The method of claim 9, comprising:
the process receiving an indication of a second allocation of memory for a second start time and second duration of time, independent of the process requesting the second allocation of memory, wherein the second allocation of memory was based on a predicted usage of memory by the process.

15. An apparatus comprising:
an interface and
circuitry to:
receive a request to allocate an amount of memory for a time duration based on receipt of a configuration that requests an allocation of the amount of memory and the configuration specifies a time tier, wherein the time duration is based on the time tier and
allocate the amount of memory for the time duration.

16. The apparatus of claim 15, wherein the request is to specify one or more of: a request identifier, the amount of memory to allocate, or a requested time duration to reserve the amount of memory.

17. The apparatus of claim 15, wherein the time tier is associated with a speed of read and/or write operations and connection latency to access the memory.

18. The apparatus of claim 15, wherein
the circuitry is to:
based on receipt of a second configuration that requests an allocation of a second amount of memory and the second configuration specifies a second time tier, allocate a second amount of memory for a second time duration, wherein the second time duration is based on the time tier and wherein the second configuration was generated automatically based on a predicted usage of memory by a process.

19. The apparatus of claim 15, wherein the memory is part of a memory pool and wherein the memory pool comprising one or more device interface-connected memory devices comprise one or more memory devices connected via one or more of: a device interface, an Ethernet-based network, or memory interface.

20. The apparatus of claim 15, wherein the request is associated with one or more of: a process, an operating system (OS), or an orchestrator.
